(19) United States
(12) Patent Application Publication
(10) Pub. No.: US 2023/0090442 A1
(43) Pub. Date: Mar. 23, 2023

(54) AUTONOMOUS FOOD PREPARATION AND MEAL PRODUCTION MACHINE

(71) Applicant: Mezli, Inc., San Mateo, CA (US)

(72) Inventors: Alexander Makris Gruebele, San Francisco, CA (US); Maxwell Emerald Perham, Palo Alto, CA (US); Yuri Alexandrovich Kolchinski, San Francisco, CA (US); Tom William Gustav Nilsson, San Mateo, CA (US)

(21) Appl. No.: 17/949,107

(22) Filed: Sep. 20, 2022

Related U.S. Application Data
(60) Provisional application No. 63/246,774, filed on Sep. 21, 2021.

(51) Int. Cl. A47J 27/04; A47J 44/00; A23L 5/10

(52) U.S. Cl. CPC A47J 27/04; A47J 44/00; A23L 5/10; A47J 2027/043; A23V 2002/00

(57) ABSTRACT

A configuration for an autonomous food preparation and meal production machine receives a menu order. A computer system of the machine retrieves from a database an automated recipe for fulfilment of the menu order and determines an availability of a threshold of ingredients to fulfill the menu order. The computer system transmits preparation instructions to fulfill the menu order to stations having controllers in a production line. The production line de-nests a vessel and moves it along a production line. The production line, in response to the controllers receiving the preparation instructions, automatically dispenses ingredients of the menu order into the vessel from dispensers, steams and heats the ingredients and places the vessel with the fulfilled menu order into a locker. The computer system transmits to a device a signal corresponding to the fulfillment of the menu order.

### CROSS REFERENCE TO RELATED APPLICATIONS

This application claims the benefit of U.S. Provisional Application No. 63/246,774, filed Sep. 21, 2021, which is incorporated by reference in its entirety.

### TECHNICAL FIELD

The disclosure generally relates to the field of autonomous food preparation and meal production machine and, more particularly, to systems, methods, and apparatuses for automatic food preparation and production.

### BACKGROUND

Food preparation and production in the restaurant service industry is labor and time intensive. Issues such as labor shortages increase food preparation and service time. The loss of productivity in this context increases overall production costs and decrease operating margin resulting from decreased throughput failing to adequately cover operating expenses. In some instances, labor shortage may cease food preparation and service altogether resulting in no revenue and further erosion or elimination of operating margin.

### SUMMARY

Disclosed is a configuration for autonomous food preparation and meal production machine. The machine includes a housing (or machine container). The housing includes one or more pick-up lockers and within it one or more a food production assembly lines. In various embodiments, the food production assembly line may include a vessel de-nester, one or more movement tracks (e.g., a first conveyor belt, a second conveyor belt, and a third conveyor belt), a first set of ingredient dispensers and a second set of ingredient dispensers, a steamer, a heating unit (or system), and a sauce dispenser. The track may be one track system with different parts or one track system that interfaces with another track system. For example, there may be one conveyor system where the first conveyor belt, the second conveyor belt, and the third conveyor belt are part of the same conveyor system. In some embodiments, the first conveyor and one of the second or the third conveyor may be part of the same system but the other conveyor may be part of a different system, e.g., a heating unit with its own conveyor. In various embodiments, a vessel is deposited by the vessel de-nester to the first track. The vessel travels along the first track to a first station. The first station may include an ingredient dispenser. The ingredient dispenser dispenses an ingredient into the vessel. In one embodiment the ingredient may be steamed at the first dispenser or adjacent to it.

The vessel may travel to one or more additional stations. Each station may include an ingredient dispenser. Each of the ingredient dispensers are part of a first set on ingredient dispensers and may dispense a separate ingredient into the vessel. In one embodiment, the vessel may travel to a second track. The second track may transport the vessel to and through the heating unit to heat ingredients within the vessel. After being heated, the vessel can then travel to a third track. The third track may allow for dispensing of one or more additional ingredients from a second set of ingredient dispensers. The second set of ingredient dispensers can dispense ingredients which are not required to be heated. The vessel can then travel to a sauce dispenser where it receives any sauce which is part of the meal to be produced. After receiving all ingredient(s) and sauce(s), the vessel can then be transported by the third track to a pick-up compartment, e.g., locker, where it can be picked up. In various embodiments, the meal could be picked up by a customer, a third-party of an autonomous delivery vehicle.

In one or more embodiments, an autonomous food preparation and meal production machine may include a housing (or machine container). Coupled with the housing may be a means for receiving a customized meal order. Further, within the housing may be a means for preparing said customized meal order. In addition, there may be a means for allowing a customer to receive said customized meal order. In various embodiments, the container comprises: one or more food production lines; and one or more pickup lockers; wherein at least one of the one or more food production lines comprises multiple stations, said stations comprising: a vessel de-nester; a means for transporting said vessel from station to station and ultimately to said pickup locker; one or more ingredient dispensers; and a heating system.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a side perspective, partial view of an example embodiment of autonomous food preparation and meal production machine.

FIG. 2 is a side perspective view of an example embodiment of an autonomous food preparation and meal production machine.

FIG. 3 is a side perspective, partial view of the autonomous food preparation and meal production machine.

FIG. 4 is a rear perspective view of the autonomous food preparation and meal production machine.

FIG. 5 is a front perspective view of the autonomous food preparation and meal production machine.

FIG. 6 is a partial, close-up side view of the autonomous food preparation and meal production machine.

FIG. 7 is a side perspective, cutaway view of the autonomous food preparation and meal production machine.

FIG. 8 is a side perspective, partial view of the autonomous food preparation and meal production machine.

FIG. 9 is a side perspective, partial view of the autonomous food preparation and meal production machine.

FIG. 10 is an example system environment in which of the autonomous food preparation and meal production machine operates.

FIG. 11 is a block diagram of an example computer system associated with the autonomous food preparation and meal production machine.

FIG. 12 is a flowchart illustrating an example process that may be encoded as program code for an example operation of the autonomous food preparation and meal production machine.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

An autonomous food preparation and meal production machine or apparatus (also referred to herein as an autonomous kitchen, auto-kitchen) is a self-contained food preparation machine and enables automated assembly and service of a completed meal order. The machine receives power as an input through established infrastructure (grid power) or sources such as built in or coupled generators or solar or liquid storage tanks. The machine also may connect with water lines (e.g., tank or established infrastructure) or gas (e.g., propane or natural gas) lines. The machine may be housed in a mobile structure such as a container (for example, a standard 20 linear foot (ft) shipping container), but the housing can take on other form factors. The size and dimensions of the apparatus of the present invention can vary. For example, the container which houses the food production equipment could have dimensions similar to a standard container of 8 ft×8 ft×20 ft or the container could be smaller (in which case it would hold fewer ingredients) or considerably larger (for example, to hold more servings or house additional assembly lines). The container may be structured from materials such as wood, metal, plastic, fiberglass or other composites.

In one or more embodiments, an autonomous food preparation and meal production machine may include a housing (an overall container for system), an input interface to receive a meal order (e.g., a point of sale (POS) order system or an mobile device app coupled with an onboard computing system of the autonomous food preparation and meal production machine), a mechanism to prepare and customize the meal order, and a delivery area for a customer to receive the customized meal order. The container may comprise one or more food production lines, one or more pickup lockers, and one or more devices for refrigerating the interior of the container.

The autonomous food producing machine may be deployed as a standalone outdoor structure, in a parking lot, at a music festival, in a food truck park, etc. or may be deployed within an inside structure, for example, in a stadium, retail store front, office cafeteria, or airport. The unit may be fully autonomous or substantially fully autonomous (e.g., human operating refilling ingredients). The machine preferably has the ability to receive a customer's order in a manner of ways. For example, the machine could receive a customer order from the web, a mobile device, or from a point of sale (POS) on the machine itself. Payment can be received at the machine or through a software application (app) or via an online ordering platform. The machine may communicate through a hardwire connection such as Ethernet, or a wireless connection such as WiFi, or an installed cellular chip. For example, the machine may communicate to a company that runs the machine, or an operator of the machine. For example, the machine may communicate information regarding the machine, such as information regarding its status. For example, the machine may communicate information such as machine health, food production, cleaning requirements, or maintenance requirements.

Communication with the machine may be two-way communications. In addition to transmitting (or sending) information, the machine may receive information, such as new recipes and functions to the machine. The communications may be enabled through an on-board computing system. The on-board computer system may include software (program code comprised of instructions) that are executable by one or more processors. The software may control the operational components of the machine as described herein. In addition, the on-board computer system may include one or more communications modules that allows for wireless communications (e.g., cellular networks such as 4G, 5G, 6G, etc., BLUETOOTH, and near field communications (NFC)). Further, the on-board computer may interface with a POS terminal coupled with the machine (or integrated with the machine) to receive a meal order. Once the meal order is received, the POS terminal software communicates with the on-board computer system the specifics of the meal order. The on-board computer system uses this information to determine what stations will be made operations to dispense the components of the meal as further described herein.

The apparatus includes built-in electronic intelligence to allow for self-recovery in the case of an error, malfunction or other operating issue. The machine is configured to provide for error self-recovery. Errors also may be resolved through remoted external sources. For example, the machine two-way communication infrastructure provides for remote connection to an external site for remote diagnostics and repair commands. Machine data and error reporting may be uploaded to the external site for further analysis, diagnostics and repairs. The repairs may be automated, e.g., firmware or software updates transmitted over the air, or may provide for specific mechanical fixes that may be transmitted to a repair person, e.g., part number, location of the mechanical fix, and instructions to install mechanical fix within the machine. The machine may further include cameras and apply computer vision to monitor any faults. Video from the cameras may be uploaded to the external site, for example, to provide visual details for diagnostics and error recovery within the machine.

The machine is configured to include food grade dispensers that also may be containers. The dispensers are fillable with ingredients or may be self-contained with ingredients and swappable. The fillable dispensers may be filled as needed and the swappable self-contained containers may be swapped as needed or when ingredients within drop below a predetermined threshold amount. For example, the machine may be filled at least once a week, every few days, or even more frequently, (for example, multiple times a day), if demand is emptying out ingredients regularly. The machine dispensers may filled (or replaced) by a human. The contents for the dispensers may be refrigerated, room temperature or heated. The ingredients may further be shelf-stable ingredients. The ingredients may be loaded into the machine through the side access hatches or by entering the machine itself through an end door and loading dispensers through an interior walkway, for example. Side hatches could comprise canape doors, rollup doors, butcher doors, or other standard doors used in modifications.

In other embodiments, the machine may autonomously fill or replace containers with a robot mechanism (or system). The robot mechanism may be within the machine or docked with the machine. Ingredients or ingredient replacement containers may be aligned within the machine in locations accessible by the robot mechanism, e.g., a robotic arm. The ingredients may be identified, for example, through hard coded identifier (e.g., each ingredient assigned a location (or slot) identifier (e.g., number)), a bar code or QR code that the robot mechanism may scan in order to identify the proper ingredient for replacement. Once an ingredient is identified for replacement, e.g., contents of a dispenser are below a threshold value, the robot mechanism identifies the dispenser, moves to the location where the ingredient is located and transfer the ingredient to the location of the container that is to be replenished. An internal computing system may update the data for the ingredient as now filled and re-set for monitoring a threshold value for replacement. In the case of replacement container (e.g., a replacement dispenser, cartridge or vessel), the robot mechanism may first remove the ingredient dispenser to be replaced and place it in a location for later pickup (e.g., for refilling, recycling, or disposing) and then retrieved and insert in the new ingredient container. The ingredients may be single ingredients (e.g., salt, pepper or spices) or completed sets of ingredients (e.g., sauces, assembled side dishes).

In addition to ingredients, the robot mechanism may be used to replenish other consumables within the machine as they deplete to below a threshold value. For example, customer consumables such as drinkware, bowls, plates, napkins, serving utensils, may be replenished using the robot mechanism. Other consumables may also be refilled or swapped such as gas for a generator, a battery, and water tanks may be refilled as needed.

The robot mechanism also may have access to cleaning and/or sanitizing materials within the container to keep the internals of the machine sanitized. For example, the robot mechanism may have a software mode that is a self-cleaning mode. In the self-cleaning mode, the robot mechanism may lock containers with ingredients to ensure no external matter can enter the container and then initiate a cleaning cycle. The cleaning cycle may use a cleaning solution and/or water (e.g., free low and/or steam) to clean and rinse locations within the machine where ingredients (or food products) may have inadvertently dropped away from a container and/or destination (e.g., a plate or a bowl). For example, if there are sauce drippings, the robot mechanism may rinse, steam, and/or apply cleaning solution in order to remove the sauce drippings. The machine may include a drain and/or garbage disposal system within the machine to capture and remove such waste. In some embodiments, the machine may be configured to be air sealed and fillable with a nitrogen or an inert gas so that the internal environment prevents oxidation of food and may inhibit growth of bacteria. In such configurations, the nitrogen or inert gas may be supplied through, for example, a tank. Pipes may couple with the interior of the machine to force in the gas. A ventilation system may be configured to remove the gas when allow entry (e.g., via a sealed door) when needed for internal maintenance or other attention.

The machine may have a raw look or be decorated. Decorations could be textured paneling such as marble, paint jobs, vinyl wrap, graffiti, wood, etc. There could be other aesthetic features such as a garden on top or other themes. The sides of the container also may be configured to provide for dynamic exchanges with customers. For example, microphones, speakers and/or display screens (or projectors) may be used, for example, to change ambiance/decoration, provide real-time menu updates, or interact customers. Additionally, cameras and display screens may be used to interact “face to face” with customers for ordering or other communications (e.g., feedback, promotions).

Besides mobile phone interaction, the customer interaction points on the machine itself may include a POS on the unit as well as a locker system, for example on the sides or end of the unit. The POS system can allow the customer to interact with their order, track progress, and pay. The lockers can be activated by the customer. For example, a customer may use their phone to activate and open the locker containing its order, for example, through use of a QR code or a passcode they are given to receive the food. The lockers may be heated to keep food warm for the customer. A screen at the POS could be used for live remote tech support from a customer service representative. In other embodiments, the POS could be all on an online ordering system with no interaction on the unit itself.

The machine can produce foods in the context of meals (e.g., menu items) including, but not limited to, grain bowls, salads, soups, desserts, cereals, pasta, and ramen. For ease of discussion, container food may be dispensed into a bowl, though it is understood other assembled food vessels (or containers) may be used, e.g., plates, trays or cups. Producing foods by the machine, includes the machine being configured to assemble (e.g., assemble ingredients together), prepare (e.g., heat or warm), and serve food on other types within the bowl or separately within a mixing container and transferred to the bowl. In some embodiments, the machine may dispense food directly into food items which serve as vessels, for example, an open pita pocket (e.g., falafel), a tortilla shell (e.g., taco salad), or a bread bowl (e.g., a chowder or chili). In some embodiments, the machine may be configured to produce foods like pizzas, wraps, or burritos in which case a base of the food (e.g., crust or flatbread) acts as its own container.

Food styles that can be produced may be further expanded if some final assembly steps are handed off to the customer. For example, a customer may receive a toasted bun, and a stack of heated and cold ingredients with a recipe card indicating how it may be assembled into a burger. In yet another example, a customer may receive a toasted pita with individual piles of ingredients and with discrete instructions to assemble the ingredients into the pita before eating, to maintain crispness of the pita.

Foods may be served chilled or cold, heated, or have a combination of heated and cold ingredients. Toppings, sides, or sauces may be provided to the customer within the bowl or separately accessible. For example, other toppings, sides, or sauces may be dispensed separately at the pick-up station, placed in a tray with the main course, dropped loosely on top of the closed main course bowl, or dispensed into recessed components of the main course bowl or its lid.

The machine is configured to process preparation of a meal through a production line. The product may run in one direction, e.g., right to left or left to right, bidirectionally to re-visit prior stations, e.g., starts right, ends left (but may go back and forth in either direction in between), or may serpentine in one direction or bidirectionally. Each configuration also may move within a single geometric plane or across geometric planes. Configurations of the machine that may implement structural projection lines that cross geographic planes and/or a serpentine production line may be where the machine footprint may have single plane linear limitations but require some additional linear distances for the overall preparation process for the meal.

In one example embodiment of a preparation of a meal process, a bowl is moved down a food production line from station to station. The food production lines may include multiple stations and one or more movement tracks that may be subdivided into stations. For example, there can be a station for a food container de-nester, one or more ingredient dispensers, one or more steamers, and a heating system. The specific stations may vary depending on the food production sought. For example, if the type of meals being produced do not require steaming, a steamer may not be included or may be included but not made operational.

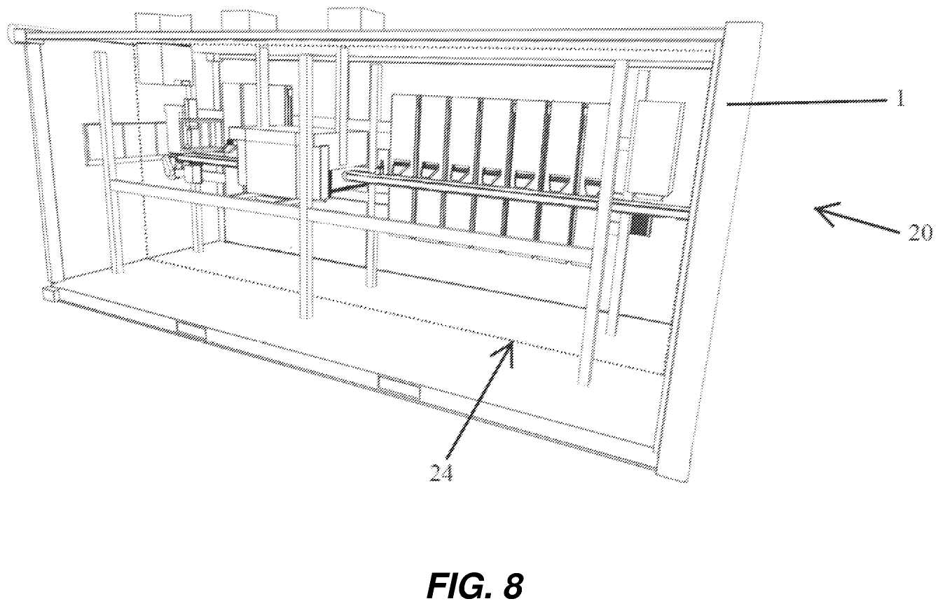

By way of example, the movement of the bowl may be through a mechanical or electromagnetic conveyer system and/or a gantry system. Movement the system may be accomplished through a track, e.g., a conveyor belt, a fixed tray on a rail conveyor, a roller conveyor, or other movement mechanism for the bowl. In one example embodiment, the track may be singular linear track, e.g., if heating is not required, or two or more distinct tracks, e.g., if various steps of dispensing and heating are built. There may be multiple lines in the unit. For example, in FIG. 8, which is further described below, there are two units mirrored down a plane through the center of the unit lengthwise. If the container is wider, there could be more food production lines. Lines could also be packed vertically one above the other if the unit is taller. Adding multiple lines increases overall food production throughput and creates redundancy wherein the machine can operate at lower throughput even if an unresolvable error shuts down a line. Also, in various embodiments which have multiple assembly lines, the assembly lines do not have to setup the same. Having multiple lines set up differently may allow for faster servicing of a wider variety of meals. For example, one assembly line may be dedicated to Mexican food bowls while another to Greek food bowls.

In some embodiments, there are multiple tracks included in the food production line. For example, there can be three tracks for a production line. A first track may receive the bowl and transport the bowl to any station before the heating unit. A second track may transport the bowl from a final station before the heating unit to the heating unit and then to another station after the heating unit. A third track may transport the vessel to any station after the heating unit and to a delivery (e.g., completed bowl) cache for placement into the one or more pick-up locations of the machine (e.g., compartments such as lockers). The delivery cache may be a location within the machine where a completed ordered menu item (e.g., completed bowl) may be placed temporarily before it is subsequently moved into a pickup location. The delivery cache may have predefined location identifiers (e.g., a box, drawer, shelf or carousel location), so that the machine, e.g., via a robotic arm and/or track may identify the bowl and move to the locker for pickup. Alternatively, the bowl may have a scannable code that a robotic arm with camera may scan to determine order and placement in locker. This process may be triggered when a customer enters a code to retrieve a bowl.

In some embodiments, there are multiple food production lines housed in the interior of the container. For example, there may be two distinct food production lines, each along a long section of the machine. Each production line may be stacked vertically to provide the linear distance necessary is the number of stations is large. Between the two food production line may be walkway and/or location for replacement dispensers or dispenser contents.

From a system operation perspective, in one example embodiment, empty bowls in the machine are stored in a bowl de-nester and deposited (e.g., dropped or slid) onto the linear track in a pre-defined and repeatable position and orientation. An example of a bowl de-nester that may be utilized is a peel de-nester, a screw de-nester, a pick and place de-nester, a pick and slide de-nester.

Next, after the bowl is de-nested and placed on the track, it is ready to continue along the track. For example, if the track is a conveyor belt, in one embodiment it may be a Dorner™ conveyor belt. The conveyor belt may be configured to add an optical rotation encoder to the motor, as well as line break sensors at each dispenser to detect when the bowl reaches each stage. For ease of discussion within the application, the embodiments herein may be described in the context of one of more tracks being one or more conveyor belts.

In one embodiment, with the bowl positioned on the track, a lubricating layer such as olive oil or butter may be sprayed into the base of the bowl using an actuated aerosol can or a pump with atomizer nozzle. This may help with preventing food from sticking to the bottom of a paper bowl during the heating step. Where a compostable plastic-coated bowl is utilized, the spraying of a lubricating layer to prevent the sticking of food may not be necessary.

In some embodiments, the track is aligned with dispensers. The dispensers are containers (or vessels) within which ingredients are stored and dispensed into the bowl. As the bowl moves along the track, a base ingredient may first be dispensed into the bowl. The base ingredient may be, for example, a rice, porridge, salad greens, a pasta, or combinations of bases. Where an ingredient for the base is to be steamed, a steamer may be situated between the grain dispensers and the rest of the ingredient dispensers. If multiple ingredients are to be steamed, the steamer may be positioned after all the ingredients which are to be steamed, or the bowl could run backwards on the conveyor to the steamer if it was at the beginning of the line. Alternatively, the machine may comprise multiple steamers in the same line.

As the bowl moves along the track, additional dispensers dispense ingredients into the bowl serially. For example, one dispenser may have vegetable followed by a dispenser for cooked chicken, followed by a dispenser for sauce.

Between dispense steps, the ingredients may be steamed within the serving bowl to rehydrate ingredients. This steamer has a plate (area equal to or larger than the customer's bowl) that is pressed onto the customer's bowl, jets in hot steam, holds for some time while the steam is absorbed, and then raises the plate again. The steam could be infused with flavoring, or a separate nozzle combined in this system could spray in a flavoring liquid to be combined with the ingredients.

The track moves the bowl from station to station, where each station may have a corresponding dispenser. At each station, the dispenser dispenses ingredients corresponding to the menu item ordered by the customer. In some embodiments, sensor (e.g., optical or positional) or camera may be used to align the bowl with the sensor. It is noted that dispensers may include other food dispensing mechanisms, for example, drums of ingredients (e.g., fed by augers), cereal style rotating paddles under tube containers of ingredient to be dispensed, and/or mechanical scoop that may have a robotic arm structured to scoop or pinch ingredients from a container (e.g., a vat). An example of a food dispensing mechanism (or dipsensor) is in U.S. Patent Application Publication 2022/0130199 (U.S. patent application Ser. No. 17/508,616, filed Oct. 22, 2021), which is incorporated by reference herein.

In some embodiments, once the bowl has received ingredients corresponding to a menu item that may require hearing, the bowl may be moved along the track into a heating unit. The heating unit may be, for example, a microwave, convection oven, an impingement oven, and/or a steamer. Additionally, the heating method can be supplemented or replaced with other means of heating such as broiling, infrared broiling, and open flame. A conveyor inside the oven preferably drives the bowl into the heating unit. With the heating unit, the bowl may be placed within an appropriate location relative to a heating element in the heating unit. For example, foods requiring more heat may be centered while those requiring less heat may be place along a periphery. The heating unit may then be sealed for the heating process, for example, with doors that retract when bowl leaves. In one or more embodiments, the heating unit includes a first door which can open to allow the vessel/bowl/food being prepared to enter the heating unit and a second door which can open to allow the vessel/bowl/food being prepared to exit the heating system. In some embodiments, both doors may close to contain the heat to within the heating system.

The heating unit may have a controller that is in communication with a computer system of the machine. The computer system of the machine can instruct the heating unit on temperature and cook time for the menu order based on the ingredients as well as factors such as pick up time, order type (delivery or carryout), and customer preferences. In addition, the computer system of the machine may place bowls for entry into the heating unit asynchronously depending on factors such as cook time, temperature and delivery time. Further, the computer system of the machine may permit two or more bowls into the heating unit if the menu order supports appropriate heating of contents in each bowl at the same time. Further, the bowls may be placed at different locations within the heating unit based on variations in temperature zones within the heating unit relative to heating elements of the heating unit.

It is noted that if the bowl in which the menu item to be served is not resistive to the heat source applied, the content may first be assembled in an appropriate heat resistant bowl and then transferred to a serving bowl, e.g., using a robot arm to coordinate transfer from the heat resistive bowl to the serving bowl.

After the ingredients are heated in the heating unit, the conveyor on the opposite side of the heating unit draws the bowl out to the cold dispensers. Cold ingredients, which may include toppings, may be dispensed on the bowl through dispensers. Preferably after cold toppings are dispensed into the bowl, highly viscous toppings (e.g., hummus, tzatziki, caramel) may be dispensed from an appropriate dispenser. In some embodiments, highly viscous toppings may be dispensed through a sauce dispenser machine that may pump out the viscous sauces in dollops where desired within the bowl. Alternate dispensers for highly viscous toppings may be, for example, a caulk-gun type plunger (e.g., a FIFO Innovations 24 oz. Portion Pal™ Portion Control Dispenser), or a peristaltic pump.

In some embodiments, there may be a dry toppings station. The dry toppings station may be configured to dispense dry toppings, for example, fried onions, dried garlic, or nuts. The dry toppings station dispenser may be a paddle type dispenser that collect a predetermined quantity of dry goods onto a paddle and as the paddle rotates, the currently collected dry toppings are dispensed into the bowl. In this process, a new set of dry toppings are collected on a second paddle aligned with an opening in the dispenser to collect the new set of dry toppings. In some embodiments, where there is no dry droppings station, optional dry toppings may be vended in pre-sealed containers to the customer at the end.

Once all the ingredients have been added to the bowl, the bowl is preferably covered with a lid or has a heat pressed film applied to the top of the bowl to cover it. After the bowl is sealed it may enter a delivery cache (e.g., a drawer, box, shelf, or carousel queue). The bowl may be transferred from the delivery cache to a locker for the user to open (e.g., with an electronic key code) to retrieve. In some embodiments, the delivery cache may itself include a warming element (e.g., built into the enclosed area or through a heat lamp) if the food is to be kept warm or a cooling element (e.g., refrigerated compartment) if the food is to be kept cool.

The delivery cache in one example embodiment may be a carousel that has a rotation track. When the customer is ready to pick up, they may enter a key code and the bowl with the order corresponding to the key code may be moved to a position to allow the customer to retrieve the bowl through an opening. The carousel may be vertical (e.g., Ferris wheel type) or horizontal (e.g., airport baggage carousel type or an elevator configuration with multiple shelves). In some embodiments, the lockers may be accessed by an autonomous delivery robot/vehicle as well or in lieu of being accessed by a customer or other individual. The pickup lockers can comprise a docking station which allows the autonomous vehicle to receive the finished food product for delivery.

In some example embodiments, machine may be configured to include a compartment where the prepared food item may be made available for retrieval. The compartment may include an opening through which the food is to be delivered includes an interlock sliding door or the like to seal the outside environment from the machine interior when the customer picks up their order. Door may include a “switchable glass” film (such as electrochromic glass) that can modulate transparency of the pickup door to prevent seeing through into the machine (e.g., when the interlock door is open, including when food is placed into the compartment at that time). The door may further the configured with a lock mechanism that may require entry via a key. A key may be, for example, a physical key, a touch keypad, a biometric keypad or camera system, a near field communication (NFC) or BLUETOOTH connection on a mobile device having an app that triggers a corresponding lock pad on the machine, or a scan image (e.g., bar code or QR code) that triggers a lock pad on the machine. The key may be provided to the customer (a user) at the time the user enters their order for the menu item.

The compartment area may include vending units to dispense bags, drinks, and/or sides. Alternatively, standard off the shelf vending units could stand freely next to the auto-kitchen machine. For example, a wireless soda machine may stand alone next to the machine, with the ability to communicate with the machine. Hence, in such an example, if the customer (user) ordered a drink with their order, the vending machine may dispense the drink while auto-kitchen machine delivers the prepared food. Similarly, if the order includes snacks, e.g., a bag of potato chips, a vending machine containing snacks may deliver that item once the food transaction is completed at the POS terminal. In certain embodiments, part of the meal can be dispensed from a separate vending machine or from vending machine type coils in the auto-kitchen. For example, a pita could be released to a customer in such a manner and then assembled by the customer with the food prepared by the auto-kitchen. An example of an off the shelf vending machine that can be suitable in certain embodiments is the Seaga® SM23 Snack & Drink Machine.

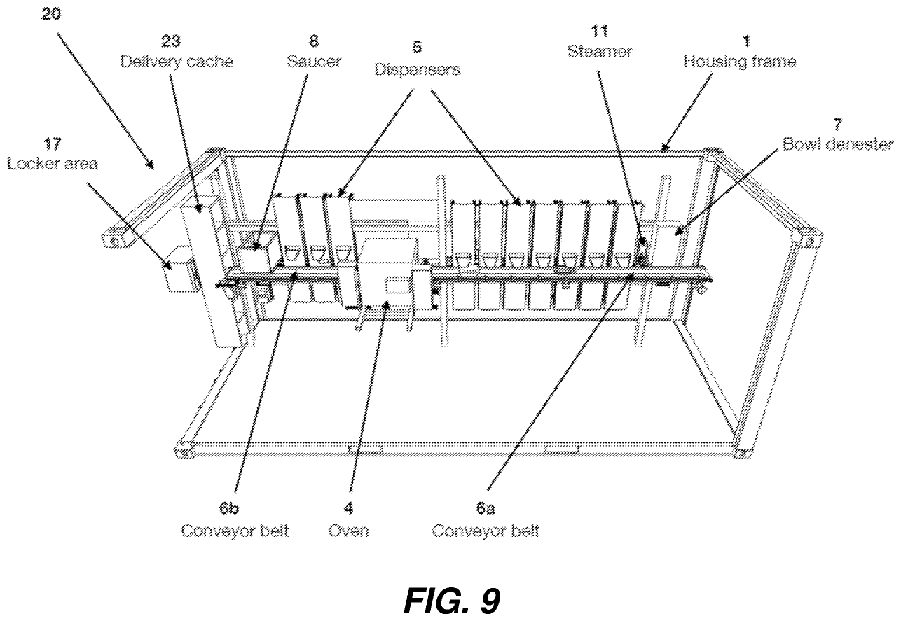

Some embodiments of the machine may include refrigeration. Refrigeration may be necessary to keep certain ingredients at food-safe temperatures as defined by local regulation (e.g., in the United States may be 40 degrees Fahrenheit). The machine may be configure to provide global refrigeration or local refrigeration. In global refrigeration, the entire interior of the machine is refrigerated using standard refrigeration units mounted on the sides or roof (such as those found on conventional “reefer” containers that are used to ship produce at refrigerated temperatures). The walls/ceiling/floor are insulated with insulation paneling. In local refrigeration, coolant such as glycol (standard in food-safe cooling systems) could be pumped through pipes/tubing built into our dispensers (e.g., front face of the units shown in FIG. 9). This would cool them locally without controlling the temperature of the air in the machine precisely. Insulation would also likely be built over these pipes onto the dispenser walls to improve efficiency. In embodiments of the machine where steam is produced by a steamer and/or ovens are deployed to heat, an HVAC or venting system may be structured within the machine in these areas to draw out steam from the unit to prevent condensation and draw air out from within the machine to an external environment. In alternate embodiments, the machine may be configured with desiccant dehumidifiers that remove moisture from the cold air and recirculate it back into the machine to improve efficiency.

In certain embodiments, the machine may include portholes or other features, such as a see-through outer layer of the container which allows for external viewing of the food production process. In various preferred embodiments, the container can have screens on the side of the container that provide entertainment and abstract the process within. In some embodiments, the machine may include one or more access hatches, e.g., to provide access to refill dispensers from an external of the machine.

### Example Machine Embodiment

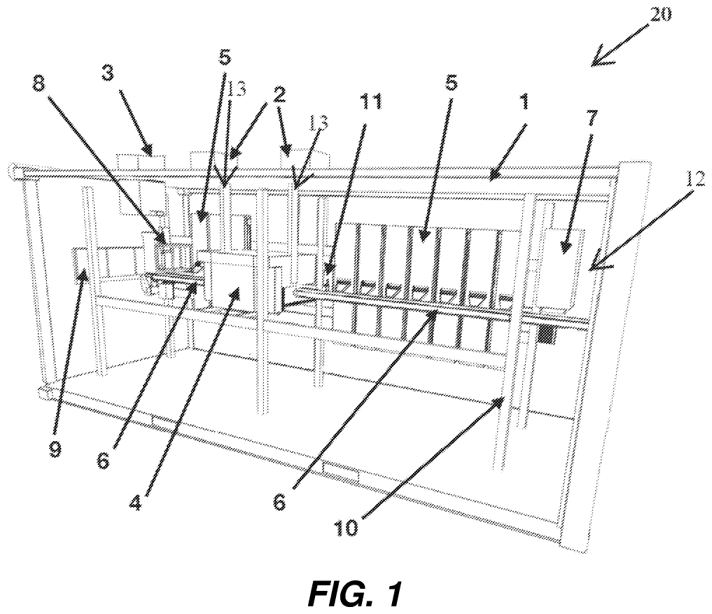

Referring now to Figure (FIG. 1, illustrated is a side perspective, partial view of an example autonomous food production machine 20. Autonomous food production machine 20 is illustrate with the side of container 1 removed to view its interior. In this example, the machine 20 may comprise an outer container 1, which may be a housing for the machine. The container 1 may also be referenced as housing 1. The housing 1, may have dimensions similar to, for example, a shipping container or a pre-fabricated or custom structure that may have a shape and size, although dimensions and materials of the housing 1 may vary in the various embodiments.

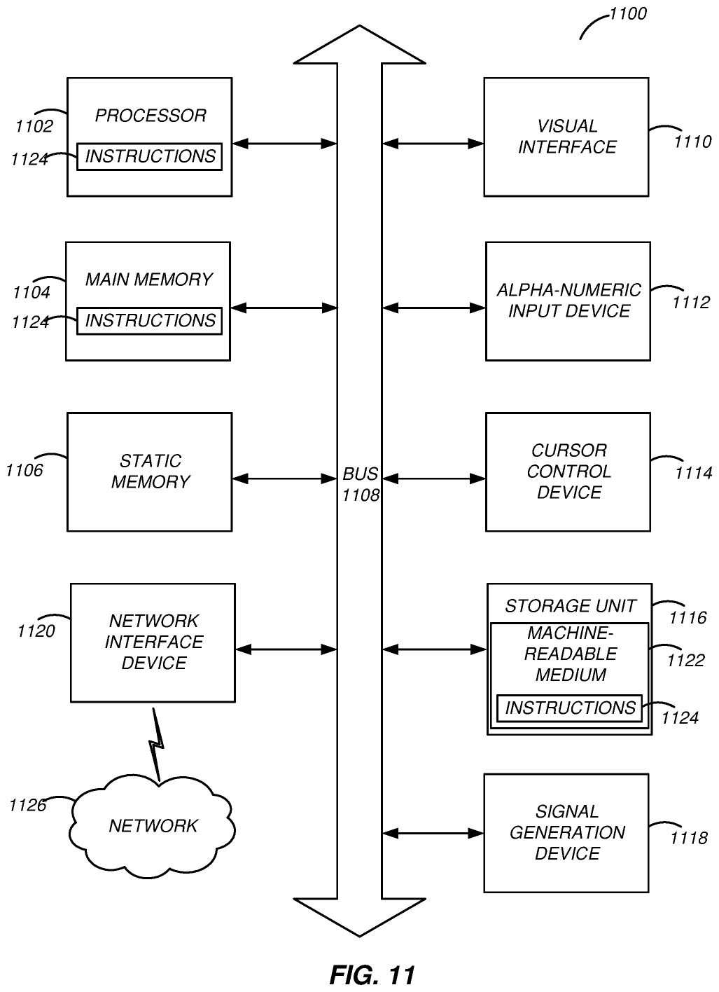

The housing 1 houses one or more food production lines 12 for the autonomous production of food. The production of food may correspond to a meal ordered through a point of sale (POS) terminal. The ordered meal may have a pre-set list of ingredients and/or may be customized starting with the pre-set list or ingredients or be a la carte. Once the order is placed through the POS terminal, that order triggers operation of the machine 20. The POS terminal is communicatively coupled with the rest of the machine 20 through a computer system, for example, a computer system having some or all the components of a computer system as described in FIG. 11. The POS terminal may be part of the same computer system or may be communicatively coupled through wired or wireless communication with a computer system for operation of the machine 20.

In one example embodiment, the machine 20 food production line 12 includes an interior framing 10 for providing structural support to the food production line 12, a vessel de-nester 7 which dispenses vessels which are ultimately served to a customer, one or more ingredient dispensers 5 to dispense various ingredients in the bowl, a saucer 8 for dispensing sauce into the bowl, a heating machine (or unit) 4 for heating the ingredients in the vessel, a steamer 11 for steaming the ingredients in the vessel, and one or more conveyor belts 6 for moving the vessel from one station to another, and ultimately, to a pickup locker 9 where the customer can receive their order. The vessel may be, for example, a plate, a bowl, a cup, or other food grade container. The vessel may be structured to receive a covering once the vessel is filled with the ingredients and the ingredients create the meal after running through the production line 12. For ease of discussion, the remainder of the specification may be described in the context of a bowl but is understood that the principles of the machine 20 and its operation may apply to any food grade vessel.

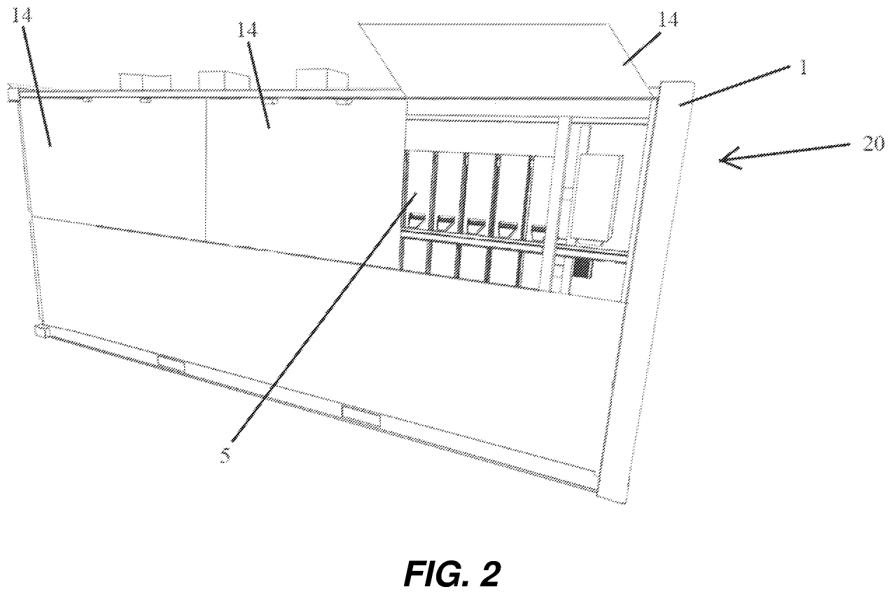

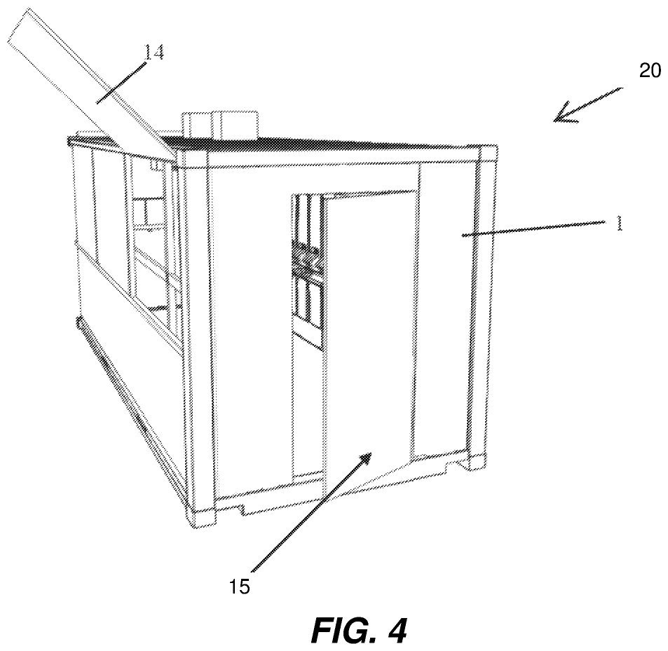

FIG. 2 illustrates a view of the machine 20 in which two of three panels are closed. The panels may be structurally configured as hatches 14. The hatches 14 may couple with the housing 1 via hinges and/or may be removable. In FIG. 2, the access hatches 14 are shown as canapé doors. In alternate embodiments, the side hatches may be canape doors, rollup doors, butcher doors, or other standard doors used in container modifications which allow one to access the interior without a need to enter the housing 1. The machine 20 may have one or more access hatches 14 to allow access the food dispensers 5 of the production line 12 or other internal parts of the machine 20. Alternatively, or in addition to access hatches 14, there may be an access door 15 allowing one to enter the housing 1, as further illustrated and described with FIG. 4.

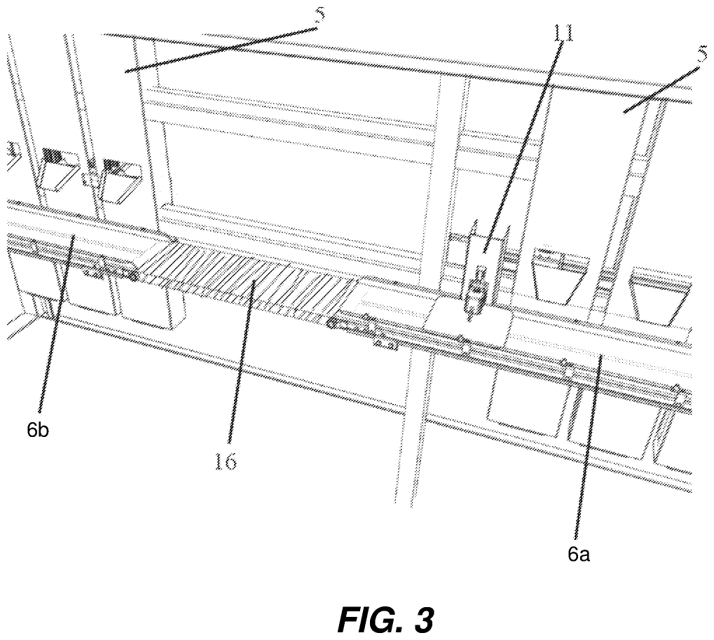

Referring next to FIG. 3, it illustrates a portion of an interior of the machine 20 within the housing 1. The figure illustrates a portion of the production line 12 with three conveyor belts. A first conveyor 6a may be configured to transport the bowl under dispensers 5, which may place ingredients into the bowl. Once the bowl passes and receives ingredients from appropriate dispensers corresponding to a menu order, the bowl is transported towards the heating system 4 (not depicted in FIG. 3). A second conveyor 16 may be configured to transport the bowl and food through the heating system 4. The third conveyor 6b may be configured to transport the bowl to additional dispensers 5 that may correspond to the menu order (e.g., toppings). The third conveyer 6b also may transport the completed menu order in the bowl to a station for sealing (not shown) and placement in a locker (not shown) for pick up.

In this example, the first conveyor 6a, the second conveyor 16 and the third conveyor 6b may be a belt conveyor, a fixed tray on a rail conveyor, a roller conveyor, or other track that allows for movement of the bowl along the production line 12. In alternate embodiments, the track system may be an electromagnetic conveyer system or gantry system with a platter that may carry the bowl. In yet other embodiments the bowl may remain stationary, and a gantry system may be structured with dispenser 5 that are rotated along a top opening of the bowl to dispense ingredients corresponding to the menu item into the bowl. Once the bowl is filled the bowl be moved to a conveyor system towards a heater, a steamer or other stations. In yet other embodiments, a gantry system also may be structured to move over and enclose a stationary bowl for heating, steaming, sealing, and/or other function post filling of the bowl, before the bowl is moved towards a locker, which also may be through a conveyor system or another gantry system that picks up a sealed bowl and moves it to a locker.

Referring back to FIG. 1, machine 20 may include a refrigeration unit 3 to keep the ingredients at food-safe temperatures, as well as multiple heating, ventilation and air conditioning (HVAC) units 2 to remove steam from the unit. Further as shown in FIG. 1, heating system 4 may have one or more vents 13.

Although food production line 12 in FIG. 1 depicts certain numbers of dispensers 5, a single steamer 11, a single heating system 4, and a single saucer 8, the disclosed configuration is not limited to such. Depending on the product sought, the number of dispensers 5, steamers 11, heating systems 4 and saucers 8 can vary. Moreover, the number of refrigeration units 3 and HVAC units 2 may also vary.

Turning to FIG. 4, illustrated is a rear perspective view of the machine 20. In this figure, illustrated is an access door 15 that allows entry into the housing 1. The access door 15 may allow entry for functions that include refilling of dispensers, cleaning of the production line 12 and/or interior of the housing 1, as well as maintenance of the machine, including access to computer system (or systems), electrical, and mechanical components.

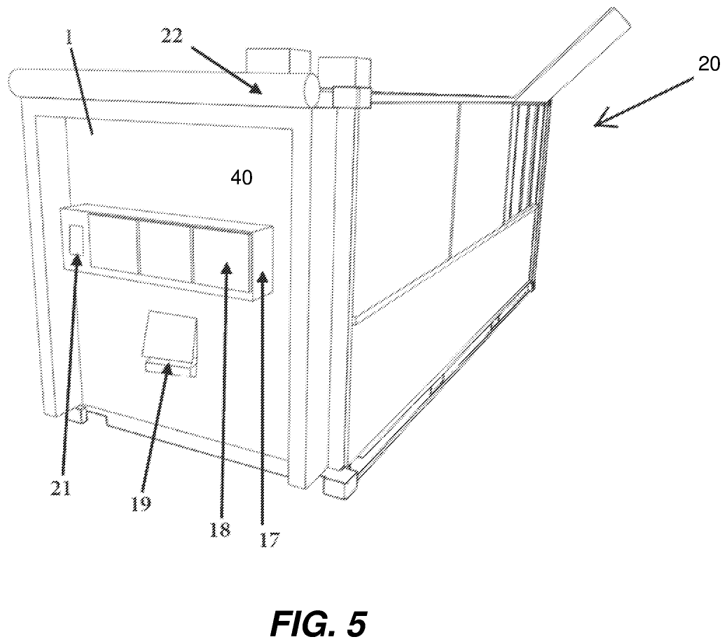

Next, FIG. 5, illustrates an exterior housing 1 perspective view of the machine 20. The example machine 20 a transaction panel 40. The transaction panel 40 includes one or more (e.g., a bank) lockers 17, each with a door 18. The door may be, for example, a hinged door, a slide door, or a roll-up door that keep contents within the locker 17 of the housing 1 until opened. Also illustrated in the transaction panel is an additional vending area, e.g., for sides and/or drinks, and an order interface unit 21. On the housing 1 is a door 22, e.g., a roll up door to cover the transaction panel 40, e.g., when the machine 20 is not operating or in transit.

As noted, the transaction area includes the interface unit 21. In one embodiment, the interface unit 21 may be configured to allow customers (or other users) to order food (e.g., POS system where a menu item is ordered) and/or location to enter a code to retrieve ordered menu items. The interface unit 21 may have its own computing system configured to communicate with the computer system of the machine 20 or may be integrated with the computer system of the machine 20.

Once a customer completes an order (e.g., selection of menu item(s) and payment) at the interface unit 21 and/or through an external source, e.g., a website or an app on a mobile device, the order is transmitted to the machine computer 20, and the POS system or app is provided a generated code for the user. The code may be, for example, a scannable code such as a QR code or a bar code, or a numeric or alphanumeric code such as a passcode. The code may be printed for the customer or may be sent electronic, e.g., to an app or text message to a mobile device. The interface unit 21 may include a scanner or keypad (physical or touch screen) that may be used to scan the generated code or enter the generated passcode. In response to a correct code or passcode being received, the machine 20 computer system allows the door 18 of the locker 17 to unlock for retrieval of the food from the locker 17. It is noted that until opened the locker 17 may be sealed to keep warm food warm and cold food cool. The locker 17 further may include a self-clean mechanism to clean inside, e.g., after a pickup.

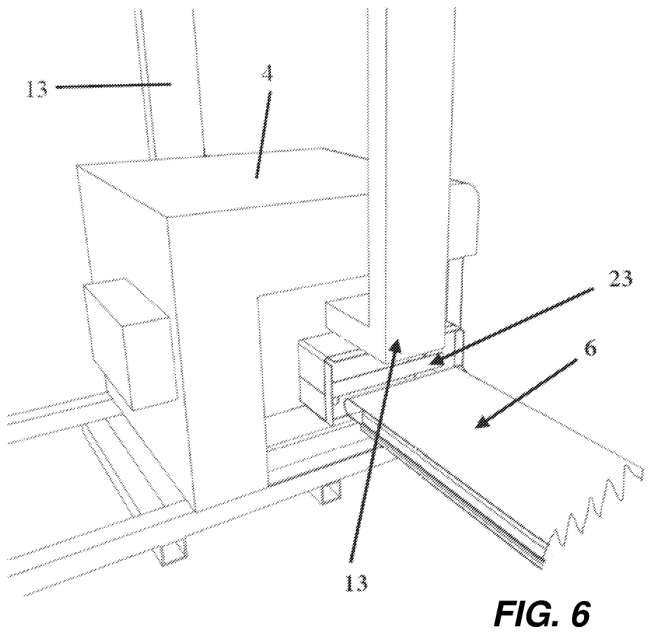

Referring back to the internal of the machine 20 and within the housing 1, FIG. 6 illustrates a close-up of an example heating system 4. The heating system 4 may include one opening for the conveyer 6 and one or more HVAC vents 13 to draw up any heat and steam after and during heating. The heating system 4 may include one or more doors 23 (for example, one on each side of the heating system 4) that may open and close as needed to allow a bowl to enter for heating and close once inside. This configuration may prevent the heat from heating up the rest of the interior of the housing 1 and provide energy savings, e.g., by not overworking compressors used for cooling systems. To open and close the heating unit as needed, the doors may be structured as a slide door or roll up type door.

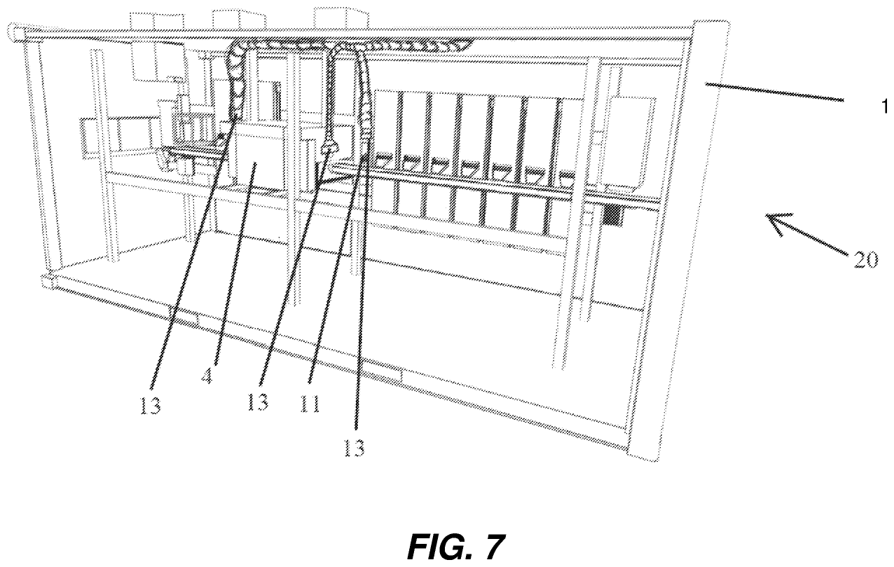

FIG. 7 illustrates a side perspective view showing example HVAC vents 13 routed from various heat sources within an interior of the housing 1. For example, as depicted, HVAC vents 13 direct heated air and steam from the heating system 4 and steamer 11 to the exterior of the container 1 of the autonomous food production machine 20. The HVAC ducts may be rigid, flexible, or both.

Next, FIG. 8 illustrates an example side perspective of a partial view of autonomous food production machine 20. Dotted line 24 identifies a center plane within the housing 1. The food production line 12 may be mirrored about the center plane to provide for two food production lines, parallel to each other, within the machine 20 housing 1. Hence, food orders may be prepared in parallel, e.g., from a first customer and a second customer or two ordered menu items from a first customer. In other embodiments, food production lines may be stacked vertically within the housing 1. In some embodiments, a height of the housing may be adjusted accordingly to account for the space in a y-plane. Further, in some embodiments where the food production line 12 is structures vertically, a horizontal footprint of the housing 1 may be adjusted, e.g., made smaller. Such structural flexibility allows for installation of the machine in locations where an x-plane area to place a machine 20 may be limited in length and/or width if the vertical height of the container 1 permits.

FIG. 9 illustrates an example perspective, interior view of another embodiment of machine 20. In this example embodiment, illustrated within the housing 1 frame is the bowl de-nester 7, one or more dispensers 5 (refrigerated or unrefrigerated), a steamer 11, one or more conveyor belts 6a, 6b (generally 6), the heating unit (e.g., oven) 4, a saucer 8 (dispenser structure for dispensing one or more sauces), a delivery cache 23, and the one or more lockers 17. The steamer 11 may be optional. In addition, an embodiment of a saucer 8 is described in U.S. patent application Ser. No. 17/848,331, filed Jun. 23, 2022, which is hereby incorporated by reference. An embodiment of the steamer 11 is described in U.S. patent application Ser. No. 17/800,791, filed Aug. 31, 2022, which is incorporated by reference.

The delivery cache 23 may be a location within the machine where a completed ordered menu item (e.g., completed bowl) may be placed temporarily before it is subsequently moved into a pickup location. The delivery cache 23 may be, for example, a box, drawer, shelf or carousel that may be configured to be part of a robotic system of the machine 20, e.g., via a robotic arm and/or track) that, when instructed by the computer system in the machine, may move a completed menu order to a locker for pickup by a customer. The delivery cache 23 may be located proximate to the locker an after the last of a food dispensing station within the machine along the production line. In some embodiments, the delivery cache 23 may move the prepared menu order to position relative to a fixed locker location for when it is ready to be fulfilled. In other embodiments, the delivery cache 23 may be fixed in location and the locker may be moved to position itself in front of a fixed delivery cache 23 location (e.g., shelf) when the prepared menu order is ready to be fulfilled.

Operationally, once a menu item is ordered, the machine 20 signals, via its computer system, the bowl de-nester 7 to place a bowl on the first conveyor 6a. The conveyor 6a is started and moves the bowl under the dispensers 5 corresponding to ingredients of the ordered menu order (or item). If one or more ingredients need to be hydrated, the first conveyor 6a positions the bowl within the steamer 11 location. The first conveyor 6a transfer the bowl to the conveyor 16 of the heating unit (or oven) 4 for heating the food. Once completed the heating unit 5 conveyor 16 transfers the bowl to the second conveyor 6b. The second conveyor 6b positions the bowls under additional dispenser units 5 that may correspond to the menu order (e.g., finishing toppings such as garnish, nuts, or seeds). The second conveyor 6b moves the bowl under the saucer 8, which applies sauces that may correspond to the menu order. Once the saucer 8 completes the second conveyor 6b moves the bowl into a locker 18. The machine 20 computer system signals the interface unit 21 that the order is completed and ready for pickup. The interface unit 21 may provide a communication to the customer, e.g., a text or message for delivery through an app on a mobile device, indicating that the order is ready for pickup. The communication may include a code for unlocking a door associated with the locker 18 where the completed menu order is awaiting pickup.

### Example System Software and Hardware Environment

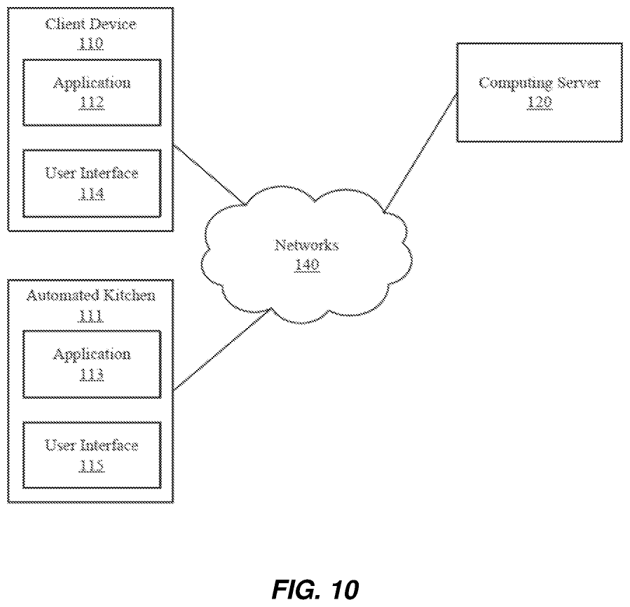

FIG. 10 is block diagram illustrating an example system environment, in accordance with some embodiments. In some embodiments, the system may include one or more client devices 110, an automated kitchen machine 111 (which may be autonomous food production machine 20), a computing server 120, and networks 140. A client device 110 may take the form of a computing device, such as a personal computer, a smartphone, a wearable device (e.g., smartwatch or fitness band), etc. In various embodiments, the system includes fewer and additional components that are not shown. The components in the system may communicate through the network 140.

While some of the components in the system environment may at times be described in a singular form while other components may be described in a plural form, the system environment may include one or more of each of the components. For simplicity, multiple instances of a type of entity or component in the system environment may be referred to in a singular form even though the system may include one or more such entities or components. For example, in some embodiments, while the client device 110 is sometimes described in a singular form, the computing server 120 may be a service provider that serves multiple client devices 110 simultaneously. Conversely, a component described in the plural form does not necessarily imply that more than one copy of the component is always needed in the environment.

A client device 110 may be controlled by a client of the server 120 who inputs various information such as actions, profiles, communities etc. The client device 110 may be referred to as a user device or an end user device. Each client device 110 may include one or more applications 112 and one or more user interfaces 114. The client devices 110 may be any computing devices. Examples of such client devices 110 include personal computers (PC), desktop computers, laptop computers, tablets (e.g., iPads), smartphones, wearable electronic devices such as smartwatches, or any other suitable electronic devices. The client device 110, server 120 and automated kitchen (e.g., an autonomous food production machine) 111 may transmit information through the network 140.

The application 112 may be configured to allow users of the client device 110 hosting application 112 to order and customize food from the automated kitchen 111. The application 112 may include a menu displaying food options that can be prepared by the automated kitchen 111. An application 112 may be in communication with the computing server 120 via the network 140. The application 112 may receive various inputs from the users comprising a choice of food items, sauces to put on the food items. The application may process user input into instructions for the controllers of the automated kitchen 111, but that processing may also occur at the automated kitchen 111.

In various embodiments and depending on the type of client device 110, the application 112 may take different forms. In one embodiment, the application 112 is a web application or a mobile application. In one embodiment, an application 112 is a web application that runs on JavaScript or other alternatives, such as TypeScript, etc. In the case of a web application, the application 112 may cooperate with a web browser, which is an example of user interface 114, to render the visual elements and interactive fields of the application 112. In another case, an application 112 is a mobile application. For example, the mobile application runs on Swift for iOS and other APPLE operating systems or on Java or another suitable language for ANDROID systems. In yet another case, an application 112 is a software program that operates on a desktop operating system such as LINUX, MICROSOFT WINDOWS, MAC OS, or CHROME OS.

Application 113 of the automated kitchen 111 may comprise all of the functional capabilities of application 112 of the client device 110. Applications 112/113 can receive user input of food item selections and more. Both applications 112/113 are updated by the server 120 such that they can display the same information. Application 112 of the client device 110 allows users of the client device 110 to order specified food items with sauce customizations from the automated kitchen 111 remotely and then pick up their meal at a later time. Application 113 allows a user of the automated kitchen 111 to order at the automated kitchen 111 using interface 115. The client device 110 communicates orders to the automated kitchen 111 while the automated kitchen 111 may also receive orders locally.

In one embodiment, the computing server 120 manages and provides the application 112/113. For example, the company operating the computing server 120 may be a cloud service provider that provides a front-end software application that can be installed, run, or displayed at a client device 110 or automated kitchen 111. For example, the company provides the applications 112/113 as a form of software as a service (SaaS). In one case, an example application 112/113 is published and made available by the company operating the computing server 120 at an application store (e.g., App store) of a mobile operating system.

The user interfaces 114 and 115 may be any suitable interfaces for receiving inputs from users and for communication with users. The user interfaces 114/115 may take different forms. In one embodiment, the user interface 114/115 is a web browser such as CHROME, FIREFOX, SAFARI, INTERNET EXPLORER, EDGE, etc. and the application 112 is a web application that is run by the web browser. In another application, the user interface 114/115 is part of the application 112/113. For example, the user interface 114/115 is the front-end component of a mobile application or a desktop application. The user interface 114/115 also may be referred to as a graphical user interface (GUI) which includes graphical elements to display various elements of the application 112/113. In another embodiment, the user interface 114/115 may not include graphical elements but communicates with the computing server 120 via other suitable ways such as application program interfaces (APIs).

User interfaces 114/115 may include visual displays of a menu of food items for selection as well as images of the food items on the menu. In one embodiment, a user may scroll through the menus to see different options. Once a user has chosen their food, they may choose the types of sauces from a sauce menu such as by checking boxes displayed in the interface 114/115. The user interface 114/115 may be similar or nearly the same on the client device 110 and the automated kitchen 111 with differing sizing and scaling across devices.

The computing server 120 is one or more computing devices that process inputs from users and generate various results. In this disclosure, the computing servers 120 may collectively and singularly be referred to as a computing server 120, even though the computing server 120 may include more than one computing device. For example, the computing server 120 is a pool of computing devices located at the same geographical location (e.g., a server room) or distributed geographically (e.g., cloud computing, distributed computing, or in a virtual server network). In some embodiments, the entity operating the computing server 120 may be the publisher of the application 112/113, which communicates with the computing server 120 to download various data generated by the computing server 120.

A computing device of the computing server 120 takes the form of software, hardware, or a combination thereof (e.g., a computing machine of FIG. 10). For example, parts of the computing server 120 may be a PC, a tablet PC, a smartphone, an internet of things (IoT) appliance, or any machine capable of executing instructions that specify actions to be taken by that machine. Parts of the server 120 may include one or more processing units (e.g., a central processing unit (CPU), a graphics processing unit (GPU), a digital signal processor (DSP), a controller, a state machine, one or more ASICs, one or more RFICs, or any combination of these) and a memory.

The communications between the client devices 110/111 and the server 120 may be transmitted via a network 140, for example, via the Internet. The network 140 may provide connections to the components of the system through one or more sub-networks, which may include any combination of local area and/or wide area networks, using both wired and/or wireless communication systems. In one embodiment, a network 140 uses standard communications technologies and/or protocols. For example, a network 140 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 140 may be represented using any suitable format, such as hypertext markup language (HTML), extensible markup language (XML), or JSON. In some embodiments, all or some of the communication links of a network 140 may be encrypted using any suitable technique or techniques such as secure sockets layer (SSL), transport layer security (TLS), virtual private networks (VPNs), Internet Protocol security (IPsec), etc. The network 140 may also include links and packet switching networks such as the Internet.

The server 120 may access a database storing food item options (e.g., ingredients), serving materials, menus, and instructions for preparing food items. The server 120 also tracks inventory levels of items. Content in the server 120 database may be updated remotely by an administrator of the system. The server 120 may then communicate its new contents via the network 140 enabling automatic updating of all client devices 110 and automated kitchens 111 remotely.

FIG. 11 is a block diagram illustrating an example architecture of a computer system 1100, in accordance with some embodiments. The computer system 1100 (or computer device) is capable of reading instructions from a computer-readable medium and executing them in a processor (or controller). A computer system 1100 described herein may include a single computing machine shown in FIG. 11, a virtual machine, a distributed computer system that includes multiples nodes of computing machines, e.g., as shown in FIG. 10, or any other suitable arrangement of computing devices.

By way of example, FIG. 11 shows a diagrammatic representation of a computing machine in the example form of a computer system 1100 within which instructions 1124 (e.g., software, program code, or machine code), which may be stored in a computer-readable medium for causing the machine to perform any one or more of the processes discussed herein may be executed. In some embodiments, the computer system 1100 operates as a standalone device or may be connected (e.g., networked) to other machines. In a networked deployment, the machine 20 may operate in the capacity of a server machine or a client machine in a server-client network environment, or as a peer machine in a peer-to-peer (or distributed) network environment.

The structure of a computer system 1100 described in FIG. 11 may correspond to any software, hardware, or combined components described above including but not limited to, the user device 111, the computing server 120, and various engines, modules, interfaces, terminals, computing nodes and machines. While FIG. 11 shows various hardware and software elements, each of the components may include additional or fewer elements.

By way of example, the computer system 1100 may be a personal computer (PC), a tablet PC, a smartphone, a tablet computer, a web appliance, a network router, an internet of things (IoT) device, a switch or bridge, or any machine capable of executing instructions 1124 that specify actions to be taken by that machine. Further, while only a single computer system 1100 is illustrated, the term “computer” may also be taken to include any collection of computer system 1100 that individually or jointly execute instructions 1124 to perform any one or more of the methodologies discussed herein.

The example computer system 1100 includes one or more processors 1102 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computer system 1100 may also include a memory 1104 that store computer code including instructions 1124 that may cause the processors 1102 to perform certain actions when the instructions are executed, directly or indirectly by the processors 1102. Instructions can be any directions, commands, or orders that may be stored in different forms, such as equipment-readable instructions, programming instructions including source code, and other communication signals and orders. Instructions may be used in a general sense and are not limited to machine-readable codes. The processors 1102 may include one or more multiply-accumulate units (MAC units) that are used to perform computations of one or more processes described herein.

One and more methods described herein improve the operation speed of the processors 1102 and reduces the space required for the memory 1104. For example, the various processes described herein reduce the complexity of the computation of the processors 1102 by applying one or more novel techniques that simplify the steps in analyzing data and generating results of the processors 1102. The algorithms described herein also reduces the size of the models and datasets to reduce the storage space requirement for memory 1104.

The performance of certain of the operations may be distributed among the one or more processors, not only residing within a single computer system 1100, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 1100 may include a main memory 1104, and a static memory 1106, which are configured to communicate with each other via a bus 1108. The computer system 1100 may further include a graphics display unit 1110 (e.g., a plasma display panel (PDP), a liquid crystal display (LCD), a projector, or a cathode ray tube (CRT)). The graphics display unit 1110, controlled by the processors 1102, displays a graphical user interface (GUI) to display one or more results and data generated by the processes described herein. The computer system 1100 may also include alphanumeric input device 1112 (e.g., a keyboard), a cursor control device 1114 (e.g., a mouse, a trackball, a joystick, a motion sensor, or other pointing instrument), a storage unit 1116 (a hard drive, a solid state drive, a hybrid drive, a memory disk, etc.), a signal generation device 1118 (e.g., a speaker), and a network interface device 1120, which also are configured to communicate via the bus 1108.

The storage unit 1116 includes a computer-readable medium 1122 on which is stored instructions 1124 embodying any one or more of the methodologies or functions described herein. The instructions 1124 may also reside, completely or at least partially, within the main memory 1104 or within the processor 1102 (e.g., within a processor's cache memory) during execution thereof by the computer system 1100, the main memory 1104 and the processor 1102 also constituting computer-readable media. The instructions 1124 may be transmitted or received over a network 1126 via the network interface device 1120.

While computer-readable medium 1122 is shown in an example embodiment to be a single medium, the term “computer-readable medium” should be taken to include a single medium or multiple media (e.g., a centralized or distributed database, or associated caches and servers) able to store instructions (e.g., instructions 1124). The computer-readable medium may include any medium that is capable of storing instructions (e.g., instructions 1124) for execution by the processors (e.g., processors 1102) and that causes the processors to perform any one or more of the methodologies disclosed herein. The computer-readable medium may include, but not be limited to, data repositories in the form of solid-state memories, optical media, and magnetic media.

In various embodiments, a non-transitory computer readable medium that is configured to store instructions may be used. The instructions, when executed by one or more processors, cause the one or more processors to perform steps described in the above computer-implemented processes or described in any embodiments of this disclosure. In various embodiments, a system may include one or more processors and a storage medium that is configured to store instructions. The instructions, when executed by one or more processors, cause the one or more processors to perform steps described in the above computer-implemented processes or described in any embodiments of this disclosure.

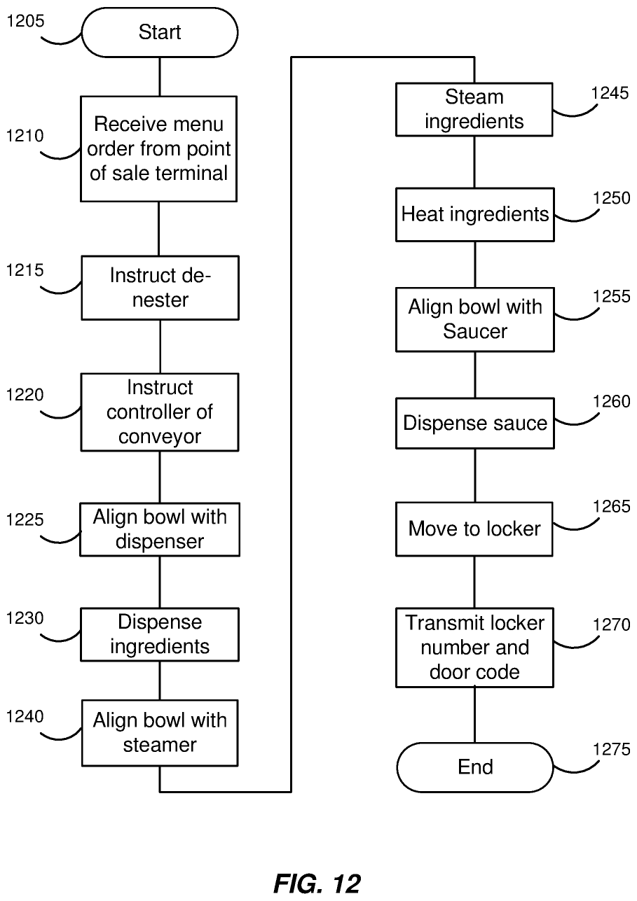

In the context of the machine 20 (and similar machine 111) one or more components of the computer system 1100 illustrated in FIG. 11 may be configured to provide a computer system structured with program code to operation the components of the machine 20. FIG. 12 illustrates and example process that may be encoded as program code (e.g., instructions) for an example operation of the machine 20. In addition, the components in the machine, e.g., the dispensers 5, the steamer 11, the heating unit 4, the conveyers 6, 16, and the de-nester 7 may be configured individually with a controller or networked controllers. Each component may also include sensors. The controllers may be communicatively coupled, e.g., wired or wireless, with the computer system 1100 or be considered part of the machine 20 computing system that includes computer 1100. In addition, the interface unit 21, lockers 17, 18, and external vending unit may be communicatively coupled with the computer system 1100 or considered part of the computer system 1100.

The process of FIG. 12 may be structured so that the computer system 1100 of the machine transmit instructions to individual controllers serially as each is activated in preparing the ordered item. The activation may be triggered by a sensor on a component. Alternately, the computer system 1100 may transmit instructions out to a subsystem such that a bowl movement may be timed to move between components. It is noted that components within the machine 20 may be referenced as stations.

In addition, the computer system 1100 is configured with a database, e.g., within the storage unit 1116, that tracks the contents within the machine 20. For example, it tracks the quantity of bowls in the de-nester, the quantity of ingredients within each dispenser 5, the quantity of sauce in the saucer, and other stations that have a replenishable amount of product or ingredients that the machine 20 will need to fulfill an order. Each station (e.g., de-nester 7, dispenser 5, saucer 8) may include a sensor that tracks a fill level within in and signals the computer system 1100 when that fill level is below a predefined threshold value. In some embodiment, the sensor may be configured to give a real-time tally of quantity dispensed and/or remaining. In addition, the heating unit 4, the steamer 11, the conveyors 6, 16, and lockers 18 may have controllers that can signal to the computer system 1100 any operational errors or problems that may require maintenance or other attention, which may impact the computer system 1100 from having the machine 20 fulfill an order. Also stored in the database (or another database) of the computer system 1100 are instructions for assembly of a menu item (food to be served). The assembly instructions stored in the database for execution by a processor, e.g., processor 1102, when an order of a menu item comes in include ordering of process flow for the bowl. This may be referenced as an automated recipe. The automated recipe may be predefined or may to provided, for example, by a customer creating an a la carte order. The automated recipe is assembled by ordering of the process flow within the machine 20 using the conveyer 6, 16 for appropriate movement. The appropriate movement includes having the bowl aligned with the stations of the machine 20 in the order they are to function, e.g., order of dispensing, steam (if applicable), mixing, heating, saucing, and serving, to assemble the automated recipe. In addition, this assembly of the automated recipe, the database includes quantities, time, and temperature, where relevant, and the appropriate location of the bowl within the station at each step. The computer system 1100 may be configured to signal and/or send instructions to specific stations (e.g., de-nester 7, dispenser 5, steamer 11, heating unit 4, conveyers 6, 16) at appropriate times based on the automated recipe.

Turning now to the process in FIG. 12, starts 1205 with the computer system 1100 receiving 1210 details of a menu order, e.g., from the interface unit 21. The computer system 1100 checks the database, e.g., within the storage unit 1116, to determine and/or confirm that there are sufficient products and ingredients, for example, within the de-nester 7 and dispensers 5, to fulfill the order. If there is a deficiency of product or ingredients, the computer system 1100 may transmit a signal to another system computer, e.g., computing serve 120, to signal replenishment of a product or ingredient is necessary to fulfill the order. If a machine 20 includes a robotic system for refills, the robotic system may be signaled to refill the contents of the deficient station, e.g., de-nester 7 or a dispenser 5. In other machine 20 embodiments, a human operator may be signaled to refill the station. If the product or ingredient is unable to be filled within a threshold period of time, the computer system 1100 may signal the interface unit 21 that a menu item is unavailable. The interface unit 21 also may be given set of products and/or ingredients that are available as well as provided for display by the computer system those menu items that the machine 20 may still be able to fulfill given adequacy of contents of product and/or ingredients. The interface unit 21 may then provide for display options for selection that may be fulfilled by the machine 20 and remove from selection (e.g., grey out visually on a display) menu items that may be temporarily unavailable due to deficiency of product and/or ingredients to make that specific menu item.

If there are sufficient products and ingredients to make the automated recipe corresponding to the ordered menu item, preparation instructions (executable by a processor or controller of a station) are generated and transmitted to appropriate stations. For example, if the automated recipe is ready to be fulfilled, the preparation instructions instruct 1215 a controller of the de-nester 7 1215 to place a bowl on the conveyer 6. A controller on the conveyer 6 is instructed 1220 to move the conveyer 6 so that the bowl may be aligned 1225 with a dispenser 5 (or other station). Alignment of the bowl may be through, for example, positional coordinates within the machine 20, via sensors on the dispenser 5, or sensors along the conveyer 6 system. Once the bowl is aligned a controller on the dispenser 5 signals the dispenser 5 to dispense 1230 ingredients in the appropriate quantity based on the automated recipe. It is noted that movement along the production line may be bi-directional or multi-directional so that the bowl may be aligned one or more times under a dispenser at different points in time. This may allow for better (e.g., even) distribution of ingredients and/or mixing of ingredients in appropriate proportions.

If ingredients need to be steamed, the conveyer 6 may move the bowl to align 1240 with the steamer 11, where the steamer 11 will steam (or rehydrate) 1245 ingredients in the bowl. If the ingredients are to be heated, the conveyer 6 will move the bowl to the heating unit 4 and transfer the bowl to the conveyer 16 of the heating unit 4. A controller of the heating unit will receive instructions to heat 1250 the bowl contents. The heat applied may be in terms of, for example, time and temperature based on the automated recipe, microwave power level (in the event the heating unit 4 is a microwave or includes a microwave), and impingement level. Once heated, the conveyer 16 of the heating until transfers the bowl to a conveyer 6. If a sauce is to be applied, the conveyer 6 aligns 1255 the bowl with the saucer 8. The saucer 8 dispenses 1260 sauce into the bowl. The conveyer 6 moves 1265 the bowl to a delivery cache 23. The delivery cache 23 may be insulated and/or may include heating or cooling elements to keep the completed menu item at an appropriate temperature. In one embodiment, when the customer is ready to pick up their order (e.g., code entered to access completed menu order), the order may be moved to the locker 18. Further it is noted that orders may be received but re-queued within the machine 20 for dynamic delivery. For example, automated recipe cook times and delivery times may be dynamically calculated to determine when to start the process or menu fulfilment. In some embodiments, a customer (e.g., user) may place a menu order via an app on, for example, a mobile device. The machine 20 computer system 1100 receives the order but may hold on preparation of the menu order until, for example, the user is ready to pick up and have their order fulfilled. In one example embodiment, the ready time for fulfilment may be based on a time set by the user, and allowable by the app (e.g., within a time window that is permitted). In another example, the app may leverage a mobile device GPS system to provide location information that is transmitted to the computer system 1100. When the user is within a predetermine radius of the machine 20, the computer system 1100 may begin preparation of the menu order.

For pick-up of the completed order, in one embodiment, the computer system 1100 may generate a code and transmit 1270 (e.g., via the network interface device 1120) a code, and information that the order is completed, to the customer, e.g., to the application 112 and user interface 114 of the client device 110 so that the customer can pick up their fulfilled order. When the completed order is ready, the computer system 1100 also stores the location of the bowl in the delivery cache 23 within its computer storage. When the customer enters their code (either on the app or at the machine 20) for pick up, the computer system 1100 of the machine 1100 receives the code and matches it to the order. The computer system 1100 instructs the robotic system (e.g., robotic arm and/or track system) as to the location of the bowl within the delivery cache 23 so that the completed order can be moved to the locker. The locker location may be predetermined by the computer system for communication to the customer. When the complete order is picked up by the customer it is fulfilled and the computer system 1100 may denote it as fulfilled in its database.

In some embodiments, the computer system 1100 may operate to transmit and receive instructions from stations of the machine 20. For example, program code of the computer system 1100 may communicatively couple with sensors and/or controllers on the dispensers 5 and/or the conveyer 6. The computer system 1100 may signal the controller of the conveyor 6 to move the conveyor until a bowl on the conveyor is directly underneath an opening of the dispenser 5. A sensor on the dispenser 5 may signal when the bowl is within an opening of the dispenser 5. This signal is received by the computer system 1100, which in turn transmits a signal to the controller of the conveyer to stop movement. When movement stops the computer system 1100 signals the dispenser 5 to drop ingredients into the bowl directly under its opening. If rehydration is required, the computer system 1100 program code may signal the controller of the conveyer 6 to move the bowl to the steamer 11 station. The steamer 11 station is optional. If it is present, when at the steamer station 11, the computer system is signaled that the bowl is ready for hydration and the computer system program code signals the steamer 11 to operate. Additional program code may be configured for timing and temperature of steam based on the ingredient to be hydrated.

Similar program code steps may be applied for other dispenser and conveyer interoperation. In addition, when the bowl reaches the oven, program code from the computer system 1100 may signal the heating unit 4 to open its door. Once open, the program code instructs the controller of the conveyer 6 to move the bowl onto the conveyer 16 of the heating unit 4. Once inside the heating unit 4, a controller on the heating unit is signaled by the computer system 1100 program code to operate. The program code may include instructions for temperature and time based on the ingredients to be heated. Once heating is completed in the heating unit 4, the computer system program code may be notified by the controller of oven and/or the computer system 1100 program code signals the controller of the heating unit 4 to open its exit door and the conveyer 16 of the heating unit transfers the bowl to another conveyer 4 for additional interaction with optional dispenser. Once those are completed, including the saucer 8, the computer system 1100 program code signals the controller on the conveyor to move so that the bowl is place in the locker 18. The computer system 1100 program code generates a signal for the interface unit 21 to transmit a signal, e.g., thought a network interface device, to a client device 110 or transmits a signal direct to the client device 110 indicating completion of an order and a generated code for opening a door on the locker 18. It is noted that in some embodiments, a display may be configured, e.g., on the machine and/or in an app on a client device, to provide a status as an order is received to when it is fulfilled.

### Additional Configuration Considerations

The disclosed configuration beneficially provides for an autonomous food preparation and meal production machine that significantly reduces or eliminates the need for human intervention is the food preparation process. The configuration automates recipes corresponding to food preparation process thereby increasing speed and throughput for service from time of order to delivery of the fulfilled order. The configuration also eliminates or significantly reduces waste through precise measurement of ingredients dispensed (e.g., through dispensers 5) and targeting delivery of ingredients directly within a vessel in which the prepared food is to be delivered (e.g., through alignment of vessel with dispenser 5). Further, consistency of quality is improved by automating controls over temperature and time, for example, at a steamer 11 or heating unit 4.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for an automated food preparation and meal production system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An autonomous food preparation and meal production machine, comprising:
a housing;
a computer system within the housing configured to receive a menu order, the computer system comprising a processor and a non-transitory computer readable storage medium comprising stored instructions executable by the processor to cause the processor to:
retrieve from a database an automated recipe for fulfilment of the menu order,
determine an availability of a threshold of ingredients to fulfill the menu order, and
transmit, in response to, the availability above a threshold, preparation instructions to fulfill the menu order;
a production line within the housing, the production line having a plurality of stations, the stations having a controller configured to receive the preparation instructions to fulfill the menu order, the production line comprising:
a vessel de-nester structured to release a vessel in response to the preparation instructions to fulfill the menu order,
a track system structured to receive the vessel and configured to move the vessel,
at least one dispenser configured to dispense ingredients corresponding to the menu order into the vessel, the ingredients dispensed upon the track system positioning the vessel relative to receiving the ingredients from an opening of the at least one dispenser; and
a locker having an opening on interior to the housing and an access door on the exterior of the housing, opening to receive the vessel from the track system,
wherein the computer system further comprises stored instructions that causes the processor to transmit a signal corresponding to the fulfillment of the menu order.

2. The machine of claim 1, wherein the production line further comprises a steamer, the streamer receiving the preparation instructions to provide a hydration to the ingredients in the vessel in response to the track system placing the vessel with the ingredients within a location for operation of the steamer.

3. The machine of claim 2, wherein the preparation instructions comprise a steam temperature and a time period to apply the hydration to the ingredients in the vessel.

4. The machine of claim 1, wherein the production line further comprises a heating unit, the heating unit receiving preparation instructions to heat the ingredients in the vessel in response to the track system placing the vessel within a location for operation of the heating unit.

5. The machine of claim 4, wherein the preparation instructions comprise an applied heat type, a heat temperature and a time period to apply the heat to the ingredients in the vessel.

6. The machine of claim 5 wherein the heating unit is an oven.

7. The machine of claim 4, wherein the production line further comprises a saucer, the saucer receiving preparation instructions to apply to the ingredients in the vessel in response to the track system placing the vessel within a location of an opening from the saucer.

8. The machine of claim 7, wherein the preparation instructions comprise releasing a predetermined volume of sauce from the saucer.

9. The machine of claim 1, wherein the production line wherein a dispenser of the at least one dispenser is a refrigerated dispenser.

10. The machine of claim 9, wherein a first dispenser of the at least one dispenser is aligned with the track system before the vessel enters the heating unit and a second dispenser of the at least one dispenser is aligned with the track to be after the vessel leaves the heating unit.

11. The machine of claim 1, further comprising an interface unit to receive input corresponding to the menu order.

12. The machine of claim 1, wherein the interface unit is a point of sale terminal, the point of sale terminal configured to provide for display a plurality of menu items selectable by a user, a selected menu item corresponding to the menu order.

13. The machine of claim 11, wherein the signal corresponding to the fulfillment of the menu order is transmitted to a client device.

14. The machine of claim 12, wherein the signal comprises information for a code associated with the access door of the locker.

15. The machine of claim 13, wherein the code is a passcode.

16. The machine of claim 13, wherein the code is a scan code and the interface until includes a scan code reader.

17. The machine of claim 7, wherein the track system further comprises:
a first track operational under the de-nester, the steamer, and a first dispenser of the at least one dispenser and configured to move the vessel towards an entrance to the heating unit; and
a second track operational under a second dispenser and the saucer and configured to move the vessel from an exit of the heating unit to an entrance of the locker.

18. The machine of claim 7, wherein the heating unit has a track configured to move the vessel from the entrance of the heating unit to an exit of the heating unit.

19. A method for autonomous food preparation and meal production, comprising:
receiving a menu order;
retrieving from a database an automated recipe for fulfilment of the menu order;
determining an availability of a threshold of ingredients to fulfill the menu order;
transmitting, in response to the availability above a threshold, preparation instructions to fulfill the menu order to stations of a production line;
de-nesting a vessel automatically in response to the preparation instructions;
dispensing automatically, in response to the preparation instructions, ingredients into the vessel from dispensers, the ingredients corresponding to the menu order;
placing automatically, the vessel into a locker; and
transmitting to a device a signal corresponding to the fulfillment of the menu order.

20. The method of claim 19, further comprising at least one of:
steaming automatically, in response to the preparation instructions, the ingredients in the vessel;
heating automatically, in response to the preparation instructions, the ingredients in the vessel; and
saucing automatically, in response to the preparation instructions, the ingredients in the vessel.
